(19) United States
(12) Patent Application Publication
(10) Pub. No.: US 2009/0256809 A1
(43) Pub. Date: Oct. 15, 2009

(54) THREE-DIMENSIONAL TOUCH INTERFACE

(75) Inventor: Sten Hakan Minor, Lund (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/102,188

(22) Filed: Apr. 14, 2008

(51) Int. Cl. G09G 5/00

(52) U.S. Cl. 345/173

(57) ABSTRACT

A device may include a display to show a representation of a three-dimensional image; a first touch panel to provide a first user input based on the display; a second touch panel to provide a second user input based on the display; and processing logic to associate the first user input and the second user input so that the first user input and the second user input emulate physical manipulation of the three-dimensional image and to alter the representation of the three-dimensional image based on the emulated physical manipulation of the three-dimensional image.

### BACKGROUND

The proliferation of devices, such as handheld and portable devices, has grown tremendously within the past decade. Many of these devices include some kind of display to provide a user with visual information, including three-dimensional renderings of various objects. These devices may also include an input device, such as a keypad, touch screen, and/or one or more buttons to allow a user to enter some form of input. However, in some instances, the input device may prove inadequate for manipulating three-dimensional objects. In other instances, the capabilities of the input device may be limited.

### SUMMARY

According to one aspect, a device may include a display to show a representation of a three-dimensional image; a first touch panel to provide a first user input based on the display; a second touch panel to provide a second user input based on the display; and processing logic to associate the first user input and the second user input so that the first user input and the second user input emulate physical manipulation of the three-dimensional image and to alter the representation of the three-dimensional image based on the emulated physical manipulation of the three-dimensional image.

Additionally, the first touch panel may be integral with the display.

Additionally, the first touch panel and the second touch panel may be in separate planes.

Additionally, the second touch panel may be substantially parallel to the first touch panel.

Additionally, the second touch panel may be substantially perpendicular the first touch panel.

Additionally, the first user input may correspond to information visible on the display and the second user input may correspond to information implied from visible information on the display.

Additionally, the device may further include a device to provide tactile simulation through at least one of the first touch panel or the second touch panel.

Additionally, the device may further include a housing, where at least one of the first touch panel or the second touch panel may be located inside the housing.

Additionally, the device may further include a memory, where the memory may store a recorded touch sequence on the first touch panel and the second touch panel and may associate the recorded touch sequence with a particular input.

According to another aspect, a method performed by a mobile device may include displaying a representation of a three-dimensional image; detecting a touch on a first panel located on the mobile device; detecting a touch on a second panel located on the mobile device; detecting relative movement between the touch on the first panel and the touch on the second panel; and altering the display of the representation of the three-dimensional image based on the relative movement.

Additionally, the first panel located on the mobile device may be overlaid on a first surface containing a display screen and the second panel located on the mobile device may be overlaid on a second surface separate from the display screen.

Additionally, the touch on the first panel may correspond to information displayed on the representation of the three-dimensional image and the touch on the second panel may correspond to information implied from the information displayed on the representation of the three-dimensional image.

Additionally, the method may include providing tactile feedback through at least one of the first panel or the second panel.

Additionally, altering the display may include rotating the three-dimensional image.

According to still another aspect, a computer-readable memory having computer-executable instructions may include one or more instructions for displaying a two-dimensional representation of an object; one or more instructions for storing information regarding three-dimensional aspects of the object; one or more instructions for determining coordinates of a touch on a first panel located on a mobile device; one or more instructions for determining coordinates of a touch on a second panel located on the mobile device; one or more instructions for associating the coordinates of the touch on the first panel with the two-dimensional representation of the object; one or more instructions for associating the coordinates of the touch on the second panel with the information regarding three-dimensional aspects of the object; one or more instructions for identifying relative changes between the coordinates of the touch on the first panel and the coordinates of the touch on the second panel; and one or more instructions for altering the two-dimensional representation of the object based on the relative changes between the coordinates of the touch on the first panel and the coordinates of the touch on the second panel.

Additionally, the computer-readable memory may further include one or more instructions for providing tactile feedback in response to the touch on the first panel or the touch on the second panel.

According to still another aspect, a device may include means for displaying a three-dimensional representation on a two-dimensional display; means for detecting a touch on a first panel located on the device; means for associating the touch on the first panel with a first surface of the three-dimensional representation; means for detecting a touch on a second panel located on the device; means for associating the touch on the second panel with a second surface of the three-dimensional representation; means for determining relative movement between the touch on the first panel and the touch on the second panel; and means for altering the display of the representation of the three-dimensional image based in the relative movement.

Additionally, the device may further include means for providing tactile feedback based on the relative movement.

In another aspect, a mobile communications device may include a housing that includes a primary surface on one plane and a secondary surface on another plane; a display, mounted on the primary surface, to render a three-dimensional representation appearing to have multiple surfaces; a touch panel to receive touch input, the touch panel being mounted with a first portion of the touch panel on the primary surface and a section portion of the touch panel on the secondary surface; processing logic to associate input to the touch panel with the display, where the first portion of the touch panel is associated with one surface of the three-dimensional representation and where the second portion is associated with another surface of the three-dimensional representation, where the rendering of the three-dimensional representation may be altered based on input from a touch pattern contacting the first portion of the touch panel and the second portion of the touch panel.

Additionally, the input may correspond to both information visible on the display and information implied from visible information on the display.

Additionally, at least a portion of the touch panel may be overlaid on the display.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1A is a diagram of the front side of an exemplary mobile device in which methods and systems described herein may be implemented;

FIG. 1B is a diagram of the back side of an exemplary mobile device in which methods and systems described herein may be implemented;

FIG. 2 is a block diagram illustrating components of the mobile device of FIGS. 1A and 1B according to an exemplary implementation;

FIG. 3 is a functional block diagram of the mobile device of FIG. 2;

FIG. 4 is an illustration of an exemplary operation on a mobile device according to an exemplary implementation;

FIG. 5 illustrates a table that may include different types of parameters that may be obtained for particular user input using the mobile device of FIGS. 1A and 1B;

FIG. 6 is an illustration of an exemplary operation on a mobile device according to another exemplary implementation; and

FIG. 7 is a flow diagram illustrating exemplary operations associated with the exemplary mobile device of FIGS. 1A and 1B.

### DETAILED DESCRIPTION

The following detailed description refers to the accompanying drawings. The same reference numbers in different drawings may identify the same or similar elements. Also, the following detailed description does not limit the invention.

### Overview

The term “touch,” as used herein, may refer to a touch of a body part (e.g., a finger) or a pointing device (e.g., a stylus, pen, etc.). A touch may be deemed to have occurred by virtue of the proximity of the body part or pointing device to a sensor, even if physical contact has not occurred. The term “touch panel,” as used herein, may refer to a touch-sensitive panel or any panel that may signal a touch when the body part or the pointing device is close to the panel (e.g., a capacitive panel, a near field panel, etc.) and that can detect the location of touches within the surface area of a touch panel. As used herein, a touch panel may be overlaid on a display screen of a device or may be located separately from the display screen. The term “touch pattern,” as used herein, may refer to a pattern that is made on a surface by tracking one or more touches within a time period.

Touch screens may be used in many electronic devices such as personal digital assistants (PDAs), smartphones, portable gaming devices, media player devices, camera devices, laptop computers, etc. A previous drawback with touch screen technology is that generally the technology has been limited to two-dimensional (“2D”) graphic interfaces. Manipulating renderings of three-dimensional (“3-D”) objects or interfaces has not been particularly intuitive. Implementations described herein provide two or more touch panels integrated with a mobile device—for example one on the front surface and one on the back surface and/or on one or more side surface—so that displayed 3-D objects and/or 3-D menus can be manipulated in a natural and intuitive manner. Additionally, tactile feedback may provide an additional dynamic for mobile devices with touch panels.

### Exemplary Device

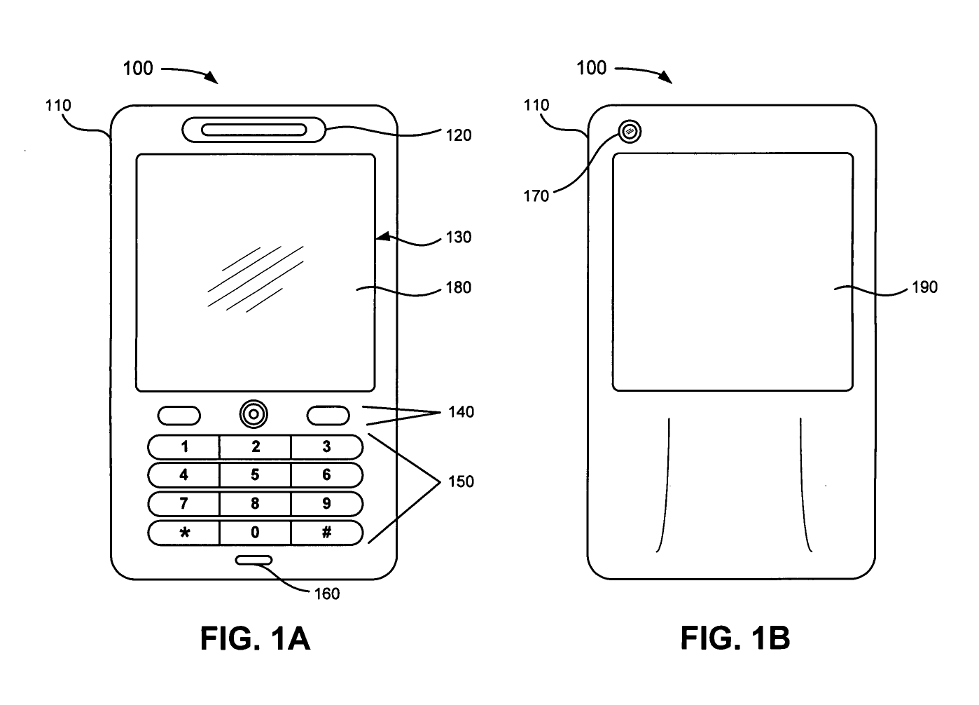

FIG. 1A is a diagram of the front of exemplary mobile device 100, and FIG. 1B is a diagram of the back of exemplary mobile device 100 in which methods and systems described herein may be implemented. Implementations are described herein in the context of a mobile device having multiple touch panels. As used herein, the term “mobile device” may include a cellular radiotelephone; a Personal Communications System (PCS) terminal that may combine a cellular radiotelephone with data processing, facsimile and data communications capabilities; a personal digital assistant (PDA) that can include a radiotelephone, pager, Internet/Intranet access, Web browser, organizer, calendar and/or a global positioning system (GPS) receiver; a gaming device; a media player device; a digital camera; a laptop and/or palmtop receiver; or another appliance that includes 3-D graphics display capabilities. Mobile devices may also be referred to as “pervasive computing” devices.

Referring collectively to FIGS. 1A and 1B, mobile device 100 may include housing 110, speaker 120, display 130, control buttons 140, keypad 150, microphone 160, camera 170, front touch panel 180, and back touch panel 190. Housing 110 may protect the components of mobile device 100 from outside elements and provide a mounting surface for certain components. Speaker 120 may provide audible information to a user of mobile device 100. Speaker 120 may include any component capable of transducing an electrical signal to a corresponding sound wave. For example, a user may listen to voices or music through speaker 120.

Display 130 may provide visual information to the user and serve—in conjunction with front touch panel 180 and back touch panel 190—as a user interface to detect user input. For example, display 130 may display information and controls regarding various applications executed by mobile device 100, such as computer-generated imagery (CGI), 3-D computer-aided design (CAD) models, 3-D menu presentations, video games, and other 3-D images. As used herein, “3-D images” may be any graphic or model that use a three-dimensional representation of geometric data that is stored in mobile device 100 for the purposes of rendering images on a 2D display. Display 130 may also provide information for other applications, such as a phone book/contact list program, a calendar, an organizer application, navigation/mapping applications, as well as other applications. For example, display 130 may present information and images associated with global positioning system (GPS) navigation services so that maps with selected routes are adjusted based on user input. Display 130 may further provide information and menu controls regarding incoming or outgoing telephone calls and/or incoming or outgoing electronic mail (e-mail), instant messages, short message service (SMS) messages, etc. Display 130 may also display images associated with a camera, including pictures or videos taken through camera lens 170 and/or received by mobile device 100. Display 130 may also display downloaded content (e.g., news, images, or other information).

Display 130 may include a device that can display signals generated by mobile device 100 as text or images on a screen (e.g., a liquid crystal display (LCD), cathode ray tube (CRT) display, organic light-emitting diode (OLED) display, surface-conduction eletro-emitter display (SED), plasma display, field emission display (FED), bistable display, etc.). In certain implementations, display 130 may provide a high-resolution, active-matrix presentation suitable for the wide variety of applications and features associated with typical mobile devices.

Control buttons 140 may be included to permit the user to interact with mobile device 100 to cause mobile device 100 to perform one or more operations, such as place a telephone call, play various media, accessing an application, etc. For example, control buttons 140 may include a dial button, hang up button, play button, etc. One of control buttons 140 may be a menu button that permits the user to view on display 130 various settings. In one implementation, control keys 140 may be pushbuttons.

Keypad 150 may also be optionally included to provide input to mobile device 100. Keypad 150 may include a standard telephone keypad. In one implementation, each key of keypad 150 may be, for example, a pushbutton. A user may utilize keypad 150 for entering information, such as a phone number, or activating a special function. Alternatively, keypad 150 may take the form of a keyboard that may facilitate the entry of alphanumeric text.

Microphone 160 may receive audible information from the user. Microphone 160 may include any component capable of transducing air pressure waves to a corresponding electrical signal. Camera 170 may include a lens for capturing a still image or video and may include other camera elements that enable mobile device 100 to take still pictures and/or videos and show them on display 130.

As shown in FIG. 1A, front touch panel 180 may be integrated with and/or overlaid on display 130 to form a touch screen or a panel-enabled display that may function as a user input interface. For example, front touch panel 180 may include a pressure-sensitive (e.g., resistive), near field-sensitive (e.g., capacitive), acoustically-sensitive (e.g., surface acoustic wave), photo-sensitive (e.g., infra-red), and/or any other type of touch panel that allows display 130 to be used as an input device. Front touch panel 180 may include the ability to identify movement of a body part or pointing device as it moves on or near the surface of front touch panel 180.

In one embodiment, front touch panel 180 may include a resistive touch overlay having a top layer and a bottom layer separated by spaced insulators. The inside surface of each of the two layers may be coated with a material—such as a transparent metal oxide coating—that facilitates a gradient across the top and bottom layer when voltage is applied. Touching (e.g., pressing down) on the top layer may create electrical contact between the top and bottom layers, producing a closed circuit between the top and bottom layers and allowing identification of, for example, X and Y touch coordinates. The touch coordinates may be associated with a portion of display 130 having corresponding coordinates.

In other implementations, front touch panel 180 may be smaller or larger than display 130. In still other implementations, front touch panel 180 may not overlap the area of display 130, but instead may be located elsewhere on the front surface of housing 110, including, for example under keypad 150 and/or control buttons 140. In other embodiments, front touch panel 180 may be divided into multiple touch panels, such as touch panels in strips around the edge of display 130. In still other implementations, front touch panel may cover display 130 and wrap around to at least a portion of one other surface of housing 110.

Back touch panel 190, as shown in FIG. 1B, may be located on or in the rear surface of housing 110. In contrast with front touch panel 180, back touch panel 190 may not be overlaid on and/or integral with display 130 or another display. Back touch panel 190 may be of the same type of touch panel technology as front touch panel 180; or back touch panel 190 may use different technology. Also, in certain implementations, back touch panel 190 may be located behind the housing 110, so as to not be visible. As described in more detail herein, back touch panel 190 may be operatively connected with front touch panel 180 and display 130 to support a user interface for mobile device 100 that accepts inputs from both front touch panel 180 and back touch panel 190.

The components described above with respect to mobile device 100 are not limited to those described herein. Other components, such as connectivity ports, memory slots, and/or additional speakers, may be located on mobile device 100, including, for example, on a rear or side panel of housing 110.

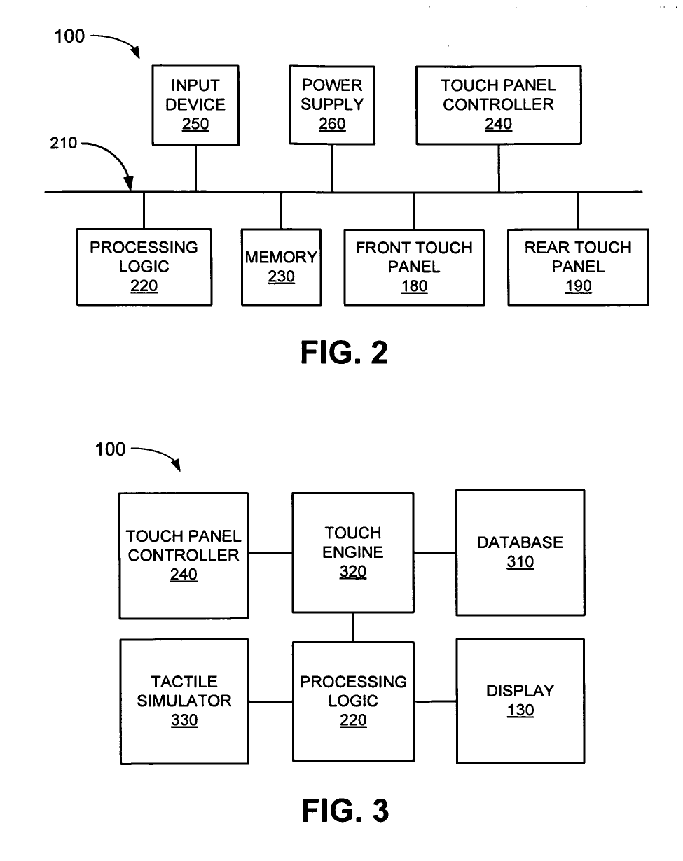

FIG. 2 is a block diagram illustrating components of mobile device 100 according to an exemplary implementation. Mobile device 100 may include bus 210, processing logic 220, memory 230, front touch panel 180, back touch panel 190, touch panel controller 240, input device 250, and power supply 260. Mobile device 100 may be configured in a number of other ways and may include other or different elements. For example, mobile device 100 may include one or more output devices, and modulators, demodulators, encoders, decoders for processing data.

Bus 210 may permit communication among the components of mobile device 100. Processing logic 220 may include a processor, a microprocessor, an application specific integrated circuit (ASIC), a field programmable gate array (FPGA), or the like. Processing logic 220 may execute software instructions/programs or data structures to control operation of mobile device 100.

Memory 230 may include a random access memory (RAM) or another type of dynamic storage device that may store information and instructions for execution by processing logic 220; a read only memory (ROM) or another type of static storage device that may store static information and instructions for use by processing logic 220; a flash memory (e.g., an electrically erasable programmable read only memory (EEPROM)) device for storing information and instructions; and/or some other type of magnetic or optical recording medium and its corresponding drive. Memory 230 may also be used to store temporary variables or other intermediate information during execution of instructions by processing logic 220. Instructions used by processing logic 220 may also, or alternatively, be stored in another type of computer-readable medium accessible by processing logic 220. A computer-readable medium may include one or more physical or logical memory devices.

Front touch panel 180 and back touch panel 190 may accept touches from a user that can be converted to signals used by mobile device 100. Touch coordinates on front touch panel 180 and back touch panel 190 are communicated to touch panel controller 240. Data from touch panel controller 240 may eventually be passed on to processing logic 220 for processing to, for example, associate the touch coordinates with information displayed on display 130.

Input device 250 may include one or more mechanisms in addition to front touch panel 180 and back touch panel 190 that permit a user to input information to mobile device 100, such as microphone 160, keypad 150, control buttons 140, a keyboard, a gesture-based device, an optical character recognition (OCR) based device, a joystick, a virtual keyboard, a speech-to-text engine, a mouse, a pen, voice recognition and/or biometric mechanisms, etc. In one implementation, input device 250 may also be used to activate and/or deactivate front touch panel 180 and/or back touch panel 190.

Power supply 260 may include one or more batteries or another power source used to supply power to components of mobile device 100. Power supply 260 may also include control logic to control application of power from power supply 260 to one or more components of mobile device 100.

Mobile device 100 may provide a 3-D graphical user interface as well as provide a platform for a user to make and receive telephone calls, send and receive electronic mail, text messages, play various media, such as music files, video files, multi-media files, games, and execute various other applications. Mobile device 100 may perform these operations in response to processing logic 220 executing sequences of instructions contained in a computer-readable medium, such as memory 230. Such instructions may be read into memory 230 from another computer-readable medium. In alternative embodiments, hard-wired circuitry may be used in place of or in combination with software instructions to implement operations described herein. Thus, implementations described herein are not limited to any specific combination of hardware circuitry and software.

FIG. 3 is a functional block diagram of exemplary components that may be included in mobile device 100. As shown, mobile device 100 may include touch panel controller 240, database 310, touch engine 320, tactile simulator 330, processing logic 220, and display 130. In other implementations, mobile device 100 may include fewer, additional, or different types of functional components than those illustrated in FIG. 3 (e.g., a web browser).

Touch panel controller 240 may identify touch coordinates from front touch panel 180 and back touch panel 190. Coordinates from touch panel controller 240 may be passed on to touch engine 320 to associate the touch coordinates with, for example, patterns of movement. Changes in the touch coordinates on front touch panel 180 and/or back touch panel 190 may be interpreted as a corresponding motion.

Database 310 may be included in memory 230 (FIG. 2) and act as an information repository for touch engine 320. For example, touch engine 320 may associate changes in the touch coordinates on front touch panel 180 and/or back touch panel 190 with particular movement scenarios stored in database 310. In another implementation, touch engine 320 may allow the user to create personalized movements, so that touch engine 320 may retrieve and/or store personalized touch patterns in database 310.

Touch engine 320 may include hardware and/or software for processing signals that are received at touch panel controller 240. More specifically, touch engine 320 may use the signal received from touch panel controller 240 to detect touches on front touch panel 180 and/or rear touch panel 190 and a movement pattern associated with the touches so as to differentiate between types of touches. The touch detection, the movement pattern, and the touch location may be used to provide a variety of user input to mobile device 100.

Processing logic 220 may implement changes in display 130 based on signals from touch engine 320. For example, in response to signals that are received at touch panel controller 240, touch engine 320 may cause processing logic 220 to “rotate” or alter the perspective of an object (e.g., a video, a picture, an object, a document, etc.) shown on display 130. In another example, touch engine 320 may cause processing logic 220 to display a menu that is associated with an item previously displayed on the touch screen at one of the touch coordinates.

In another example, processing logic 220 may coordinate touch signals from touch engine 320 with tactile feedback using tactile simulator 330. For example, in certain implementations, mobile device 100 may be a video game player capable of generating audio, video, and control outputs upon reading a software program having encoded simulation control information. Tactile simulator 330 may provide one or more indicators (e.g., movement, heat, vibration, etc.) in response to control signals from processing logic 220. For example, tactile simulator may provide feedback by vibration of one or more touch panels based on the user input on front touch panel 180 and/or back touch panel 190.

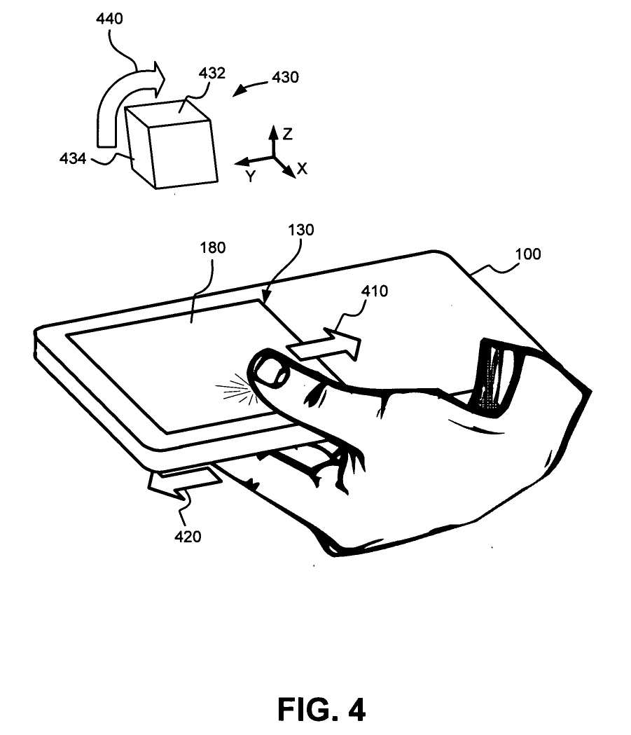

FIG. 4 is an illustration of an exemplary operation of mobile device 100 according to an exemplary implementation. Mobile device 100 may include display 130, front touch panel 180 and back touch panel 190 (not visible in FIG. 4, but shown in FIG. 1B). As shown in FIG. 4, a user may position a thumb on the surface of front touch panel 180 and a finger on the surface of back touch panel 190. The thumb may move in direction 410 along the surface of front touch panel 180, while the finger may move in opposite direction 420 along the surface of back touch panel 190. The movement of the thumb and finger may be interpreted by mobile device 100 as rotational movement around the X-axis in FIG. 4.

A 3-D image, object 430, may be shown on display 130. Object 430 is shown separated from display 130 in FIG. 4 for illustrative purposes. In the example of FIG. 4, as the movement of the thumb and finger proceeds in directions 410 and 420, respectively, object 430 may rotate in direction 440 corresponding to directions 410 on a top surface of object 430 and corresponding to direction 420 on a bottom surface (not visible) of object 430. Thus, display 130 may show the orientation of object 430 rotate from displaying surface 432 as the top surface to displaying surface 434 as the top surface based on the movement of the user's thumb and finger.

In the implementation of FIG. 4, front touch panel 180 and back touch panel 190 are in separate planes. Thus the direction of movement 410 on front touch panel 180 and the opposite direction of movement 420 on back touch panel 190 may emulate physical manipulation of the 3-D image, object 430. While the user input from the thumb on front touch panel 180 may correspond to the directly visible information on display 130, the input from the user's finger on back touch panel 190 may correspond to information implied from visible information on display 130. More specifically, back touch panel 190 may correspond to the bottom surface of a graphic model that would not be visible in the 3-D rendering shown on display 130. Thus, referring to the example in FIG. 4, the user's thumb may be initially applied to front touch panel 180 on the apparent surface 432 of object 430, while the user's finger may be applied to back touch panel 190 on what would intuitively be the non-visible opposite surface of object 430.

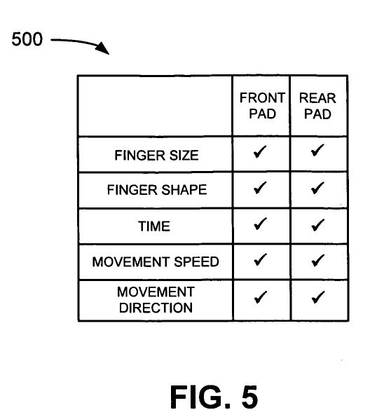

The directions 410 and 420 represented in FIG. 4 are exemplary. Other movements or combinations of movements may be used to intuitively manipulate a 3-D image displayed on display 130. For example, a user may keep one finger stationary on one touch panel, such as touch panel 190, to “anchor” the displayed image while using another finger, on touch panel 180 for example, to reorient the 3-D image displayed on display 130. In certain implementations, two or more fingers may be used on each touch panel to provide user input. In other implementations, mobile device 100 may allow the user to record personalized touch patterns so that motions most-intuitive to a particular user may be stored and recalled for subsequent user input sequences. FIG. 5 illustrates a table that may include different types of parameters that may be obtained for particular touch patterns using mobile device 100.

FIG. 5 provides an exemplary table 500 of touch parameters that may be stored in mobile device 100 and specifically in, for example, database 310 (FIG. 3). In certain implementations, a particular combination of touch movements may be stored in memory and recognized by mobile device 100, so that mobile device 100 may effectively “learn” touch patterns of a particular user. As shown in table 500, elements of a stored touch pattern may include the finger size registered on a touch pad, the finger shape registered on a touch pad, the length of time of the touch, the movement speed, and/or the movement direction.

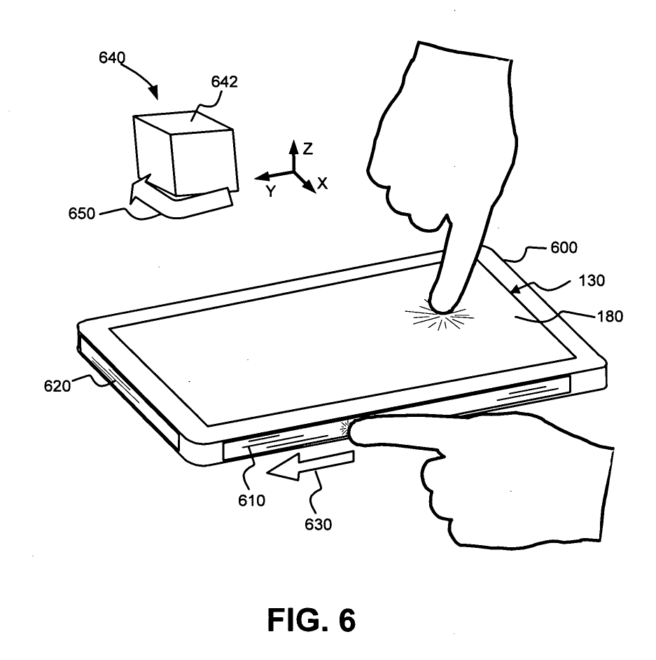

FIG. 6 provides an illustration of an exemplary operation on a mobile device according to another exemplary implementation. Mobile device 600 may include display 130, front touch panel 180, left side touch panel 610 and top touch panel 620. Additional panels (not visible in FIG. 6) may optionally be included on the right side, bottom or rear surface of mobile device 600. As shown in FIG. 6, a user may position a finger on the surface of front touch panel 180 and a finger on the surface of left side touch panel 610. The finger on left side touch panel 610 may move in direction 630 along the surface of the left side touch panel 610, while the finger on front touch panel 180 may remain stationary. The movement of the finger along left side touch panel 610 (in direction 630) and the stationary position of the finger on the surface of front touch panel 180 may be interpreted by mobile device 100 as rotational movement around the Z-axis in FIG. 6.

A 3-D image, object 640, may be shown on display 130. Object 640 is shown separated from display 130 in FIG. 6 for illustrative purposes. In the example of FIG. 6, as the movement of the finger proceeds along left side touch panel 610 in direction 630, object 640 may rotate in direction 650 corresponding to the movement of the finger along the left side panel. Thus, display 130 may show the orientation of object 640 rotate along the Z-axis while surface 642 remains visible to the user.

Using the touch panels 600, 610 and/or 620, other touch movements or combinations of movements may be used to intuitively manipulate a 3-D image displayed on display 130. Also, while front touch panel 600, left side touch panel 610, and top touch panel 620 are shown as separate panels, two or more of these panels may be combined in some implementations as a single touch panel. Thus, a user touch may rotate the visible surface of an object on display 130 to a non-visible orientation by dragging his finger from, for example, the portion of the touch panel on the front surface of mobile device 600 to portion of the touch panel on a side surface of mobile device 600.

In other implementations, touch panels—such as front touch panel 600, left side touch panel 610, and/or top touch panel 620—may be integrated with one or more tactile simulators (such as tactile simulator 330 of FIG. 3). In one implementation, the tactile simulator may include, for example, a tactile bar on which the touch panels may be mounted. Signals may be transmitted to the tactile bar by the processing logic (such a processing logic 220 of FIG. 2) to control the motion of weights located within the tactile bar, vibration of motors within the tactile bar, and/or temperature changes of the tactile bar. For example motors having eccentric weights may be used to cause the tactile bar to selectively vibrate. Additionally, movement of weights within the tactile bar may impart a sense of motion.

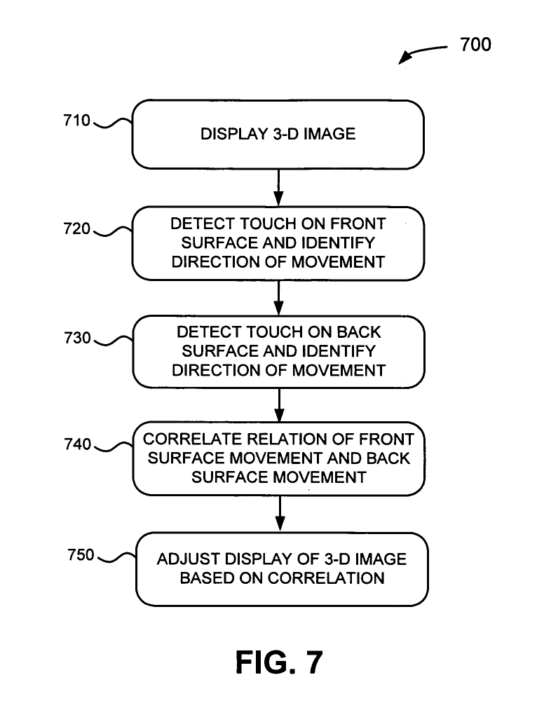

FIG. 7 is a flow diagram illustrating an exemplary operation associated with implementations of a mobile device, such as mobile device 100. A 3-D image may be displayed (block 710). For example, mobile device 100 may present the 3-D image on display 130. A user may desire to view other perspectives of the image and engage touch panels on mobile device 100 to rotate the image. The user may place his thumb on a touch panel on the front surface of mobile device 100. The touch on the front surface may be detected and a direction of movement on the front surface may be identified, if any (block 720). For example, mobile device 100 may detect a touch and movement of the user's thumb as it moves on the front touch panel. A touch on the back surface may be detected and a direction of movement on the back surface may be identified, if any (block 730). For example, the user may place his finger on a touch panel on the back surface of mobile device 100. Mobile device 100 may detect the touch on the back panel and identify a direction of movement of the finger.

The relation of the front surface movement and the back surface movement may be correlated (block 740). For example, based on the motion of the thumb and finger on the front and back touch panels, mobile device 100 may correlate a relation of movement along the front panel and movement along the back panel. The movement may be correlated with the displayed image so as to indicate rotation about a particular axis. In block 750, the display of the 3-D image may be adjusted based on the correlation of the front surface movement and the back surface movement. Thus, for example, mobile device 100 may adjust the display of the 3-D image based on the correlation of the movement of the user's finger and thumb.

### Conclusion

Implementations described herein may include a mobile device with a display and multiple touch panels. The touch panels may be positioned on various locations on the mobile device, including, for example, on the display screen and on the back surface of the mobile device and/or on one or more side surfaces. The user of the mobile device may simultaneously touch two or more touch panels to manipulate displayed 3-D objects in a natural and intuitive manner.

The foregoing description of the embodiments described herein provides illustration and description, but is not intended to be exhaustive or to limit the invention to the precise form disclosed. Modifications and variations are possible in light of the above teachings or may be acquired from practice of the invention.

For example, implementations have been mainly described in the context of a mobile device. These implementations, however, may be used with any type of device that includes a display with more than one accessible surface.

As another example, implementations have been described with respect to certain touch panel technology. Other technology may be used to accomplish certain implementations, such as different types of touch panel technologies, including but not limited to, resistive touch panels, surface acoustic wave technology, capacitive touch panels, infrared touch panels, strain gage mounted panels, optical imaging touch screen technology, dispersive signal technology, acoustic pulse recognition, and/or total internal reflection technologies. Furthermore, in some implementations, multiple types of touch panel technology may be used within a single device.

Further, while a series of blocks has been described with respect to FIG. 7, the order of the blocks may be varied in other implementations. Moreover, non-dependent blocks may be performed in parallel.

Aspects described herein may be implemented in methods and/or computer program products. Accordingly, aspects may be embodied in hardware and/or in software (including firmware, resident software, micro-code, etc.). Furthermore, aspects described herein may take the form of a computer program product on a computer-usable or computer-readable storage medium having computer-usable or computer-readable program code embodied in the medium for use by or in connection with an instruction execution system. The actual software code or specialized control hardware used to implement these aspects is not limiting. Thus, the operation and behavior of the aspects were described without reference to the specific software code—it being understood that software and control hardware could be designed to implement the aspects based on the description herein.

Further, certain aspects described herein may be implemented as “logic” that performs one or more functions. This logic may include hardware, such as a processor, microprocessor, an application specific integrated circuit or a field programmable gate array, software, or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

The scope of the invention is defined by the claims and their equivalents.

What is claimed is:

1. A device comprising:
a display to show a representation of a three-dimensional image;
a first touch panel to provide a first user input based on the display;
a second touch panel to provide a second user input based on the display; and
processing logic to:
associate the first user input and the second user input so that the first user input and the second user input emulate physical manipulation of the three-dimensional image, and
alter the representation of the three-dimensional image based on the emulated physical manipulation of the three-dimensional image.

2. The device of claim 1, where the first touch panel is integral with the display.

3. The device of claim 1, where the first touch panel and the second touch panel are in separate planes.

4. The device of claim 1, where the second touch panel is substantially parallel to the first touch panel.

5. The device of claim 3, where the second touch panel is substantially perpendicular the first touch panel.

6. The device of claim 1, where the first user input corresponds to information visible on the display and where the second user input corresponds to information implied from visible information on the display.

7. The device of claim 1, further comprising a device to provide tactile simulation through at least one of the first touch panel or the second touch panel.

8. The device of claim 1, further comprising a housing, where at least one of the first touch panel or the second touch panel is located inside the housing.

9. The device of claim 1, further comprising a memory, where the memory stores a recorded touch sequence on the first touch panel and the second touch panel and associates the recorded touch sequence with a particular input.

10. A method performed by a mobile device, the method comprising:
displaying a representation of a three-dimensional image;
detecting a touch on a first panel located on the mobile device;
detecting a touch on a second panel located on the mobile device;
detecting relative movement between the touch on the first panel and the touch on the second panel; and
altering the display of the representation of the three-dimensional image based on the relative movement.

11. The method of claim 10, where the first panel located on the mobile device is overlaid on a first surface containing a display screen and the second panel located on the mobile device is overlaid on a second surface separate from the display screen.

12. The method of claim 10, where the touch on the first panel corresponds to information displayed on the representation of the three-dimensional image and where the touch on the second panel corresponds to information implied from the information displayed on the representation of the three-dimensional image.

13. The method of claim 10, further comprising providing tactile feedback through at least one of the first panel or the second panel.

14. The method of claim 10, where altering the display comprises rotating the three-dimensional image.

15. A computer-readable memory comprising computer-executable instructions, the computer-readable memory comprising:
one or more instructions for displaying a two-dimensional representation of an object;
one or more instructions for storing information regarding three-dimensional aspects of the object;
one or more instructions for determining coordinates of a touch on a first panel located on a mobile device;
one or more instructions for determining coordinates of a touch on a second panel located on the mobile device;
one or more instructions for associating the coordinates of the touch on the first panel with the two-dimensional representation of the object;
one or more instructions for associating the coordinates of the touch on the second panel with the information regarding three-dimensional aspects of the object;
one or more instructions for identifying relative changes between the coordinates of the touch on the first panel and the coordinates of the touch on the second panel; and
one or more instructions for altering the two-dimensional representation of the object based on the relative changes between the coordinates of the touch on the first panel and the coordinates of the touch on the second panel.

16. The computer-readable memory of claim 15, further comprising:
one or more instructions for providing tactile feedback in response to the touch on the first panel or the touch on the second panel.

17. A device comprising:
means for displaying a three-dimensional representation on a two-dimensional display;
means for detecting a touch on a first panel located on the device;
means for associating the touch on the first panel with a first surface of the three-dimensional representation;
means for detecting a touch on a second panel located on the device;
means for associating the touch on the second panel with a second surface of the three-dimensional representation;
means for determining relative movement between the touch on the first panel and the touch on the second panel; and
means for altering the display of the representation of the three-dimensional image based in the relative movement.

18. The device of claim 17, further comprising:
means for providing tactile feedback based on the relative movement.

19. A mobile communications device comprising:
a housing that includes a primary surface on one plane and a secondary surface on another plane;
a display, mounted on the primary surface, to render a three-dimensional representation appearing to have multiple surfaces;
a touch panel to receive touch input, the touch panel being mounted with a first portion of the touch panel on the primary surface and a section portion of the touch panel on the secondary surface;
processing logic to associate input to the touch panel with the display, where the first portion of the touch panel is associated with one surface of the three-dimensional representation and where the second portion is associated with another surface of the three-dimensional representation, where the rendering of the three-dimensional representation is altered based on input from a touch pattern contacting the first portion of the touch panel and the second portion of the touch panel.

20. The device of claim 19, where the input corresponds to both information visible on the display and information implied from visible information on the display.

21. The device of claim 19, where at least a portion of the touch panel is overlaid on the display.
